(19) United States
(12) Patent Application Publication
(10) Pub. No.: US 2024/0242443 A1
(43) Pub. Date: Jul. 18, 2024

(54) PROXIMITY-BASED PROTOCOL FOR ENABLING MULTI-USER EXTENDED REALITY (XR) EXPERIENCE

(71) Applicant: QUALCOMM Incorporated, San Diego, CA (US)

(72) Inventors: Adithya Reddy NALLABOLU, San Diego, CA (US); Upal MAHBUB, Santee, CA (US); Samuel SUNARJO, Vista, CA (US); Gokce DANE, San Diego, CA (US)

(21) Appl. No.: 18/153,498

(22) Filed: Jan. 12, 2023

(51) Int. Cl. G06T 19/00; G06F 3/01; G06F 21/35

(52) U.S. Cl. CPC G06T 19/006; G06F 3/012; G06F 3/013; G06F 21/35; G06T 2219/024

(57) ABSTRACT

Systems and techniques are described herein for enabling a multi-user extended reality (XR) experience. In one illustrative example, a user device can receive, associated with a user from a host device, a message comprising a prompt to join an XR room hosted by the host device. The user device can connect to the host device based on the message. The user device can can obtain images of a three-dimensional (3D) scene of a physical environment and can transmit the images to the host device. The user device can receive synthetic content from the host device. A virtual representation of the user can be localized with respect to the XR room based on features in the images matched with features of the 3D scene of the physical environment. The user device can render the synthetic content for the XR room based on a pose of the apparatus.

### TECHNICAL FIELD

The present disclosure generally relates to processing virtual content for virtual environments or partially virtual environments. For example, aspects of the present disclosure include systems and techniques for providing a proximity-based protocol for enabling a multi-user extended reality (XR) experience.

### BACKGROUND

An extended reality (XR) (e.g., virtual reality, augmented reality, mixed reality) system can provide a user with a virtual experience by immersing the user in a completely virtual environment (made up of virtual content) and/or can provide the user with an augmented or mixed reality experience by combining a real-world or physical environment with a virtual environment.

It can be desirable for users to augment their physical three-dimensional (3D) space with synthetic content. These users may want to share their augmented 3D scenes (e.g., which may each be referred to as an XR room) with other people. The sharing of XR rooms can have multiple applications, such as for classrooms, restaurants, businesses, factories, homes (e.g., living rooms and kitchens), museums, etc. These XR rooms can be multi-functional by providing interactive information, entertainment, and/or a synthesized light experience for the users. As such, with such ubiquitous XR rooms, a unified framework may be needed to help users join, host, and navigate through the XR rooms.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for providing a multi-user extended reality (XR) experience. According to at least one illustrative example, a method of providing an XR experience is provided. The method includes: receiving, by a user device associated with a user from a host device, a message comprising a prompt to join an XR room hosted by the host device; connecting to the host device based on the message; obtaining, by the user device, images of a three-dimensional (3D) scene of a physical environment; transmitting, by the user device, the images to the host device; receiving, by the user device, synthetic content from the host device, wherein a virtual representation of the user is localized with respect to the XR room based on features in the images matched with features of the 3D scene of the physical environment; and rendering, by the user device, the synthetic content for the XR room based on a pose of the user device.

In another illustrative example, an apparatus associated with a user for providing an extended reality (XR) experience is provided. The apparatus includes at least one memory and at least one processor coupled to the at least one memory and configured to: receive, associated with a user from a host device, a message comprising a prompt to join an XR room hosted by the host device; connect to the host device based on the message; obtain images of a three-dimensional (3D) scene of a physical environment; transmit the images to the host device; receive synthetic content from the host device, wherein a virtual representation of the user is localized with respect to the XR room based on features in the images matched with features of the 3D scene of the physical environment; and render the synthetic content for the XR room based on a pose of the apparatus.

In another illustrative example, a non-transitory computer-readable medium of a user device associated with a user is provided. The non-transitory computer-readable medium having has instructions that, when executed by at least one processor, cause the at least one processor to: receive, associated with a user from a host device, a message comprising a prompt to join an XR room hosted by the host device; connect to the host device based on the message; obtain images of a three-dimensional (3D) scene of a physical environment; transmit the images to the host device; receive synthetic content from the host device, wherein a virtual representation of the user is localized with respect to the XR room based on features in the images matched with features of the 3D scene of the physical environment; and render the synthetic content for the XR room based on a pose of the apparatus.

In another illustrative example, an apparatus associated with a user for providing an extended reality (XR) experience is provided. The apparatus includes: means for receiving, from a host device, a message comprising a prompt to join an XR room hosted by the host device; means for connecting to the host device based on the message; means for obtaining images of a three-dimensional (3D) scene of a physical environment; means for transmitting the images to the host device; means for receiving synthetic content from the host device, wherein a virtual representation of the user is localized with respect to the XR room based on features in the images matched with features of the 3D scene of the physical environment; and means for rendering the synthetic content for the XR room based on a pose of the apparatus.

In some aspects, one or more of the apparatuses described herein is, is part of, and/or includes an XR device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of an extended reality (XR) system, according to aspects of the disclosure;

FIG. 2 is a diagram illustrating an example of a three-dimensional (3D) collaborative virtual environment, according to aspects of the disclosure;

FIG. 3 is a block diagram illustrating an architecture of an example of an XR system, in accordance with some examples;

FIG. 4 is a block diagram illustrating an architecture of a simultaneous localization and mapping (SLAM) device, in accordance with some examples;

FIG. 5 is a flowchart illustrating an example of a process for 3D reconstruction and generation of a features database, in accordance with some examples of the present disclosure;

FIG. 6 is a flowchart illustrating an example of a process for authentication and localization of a user with a head-mounted device (HMD), in accordance with some examples of the present disclosure;

FIG. 7 is a diagram illustrating an example of users, who are located within proximity of an XR room, being enabled to join the XR room, in accordance with some examples of the present disclosure;

FIG. 8 is a diagram illustrating an example of businesses having respective XR rooms, in accordance with some examples of the present disclosure;

FIG. 9 is a diagram illustrating an example of users co-hosting an XR room, in accordance with some examples of the present disclosure;

FIG. 10 is a diagram illustrating an example of a user interacting with synthetic content within an XR room, in accordance with some examples of the present disclosure;

FIG. 11 is a diagram illustrating an example of an XR classroom, in accordance with some examples of the present disclosure;

FIG. 12 is a diagram illustrating an example of XR sub-rooms within an XR classroom, in accordance with some examples of the present disclosure;

FIG. 13 is a flowchart illustrating an example of a process for enabling multi-user XR experience, in accordance with some examples of the present disclosure; and

FIG. 14 is a diagram illustrating an example of a computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

An extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs), smart glasses (e.g., AR glasses, MR glasses, etc.), among others.

XR systems can include virtual reality (VR) systems facilitating interactions with VR environments, augmented reality (AR) systems facilitating interactions with AR environments, mixed reality (MR) systems facilitating interactions with MR environments, and/or other XR systems. For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include any virtual content, such as video, images, graphic content, location data (e.g., global positioning system (GPS) data or other location data), sounds, any combination thereof, and/or other augmented content. An AR system is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

As previously mentioned, it may be desirable for users to augment a physical three-dimensional (3D) space surrounding the users with synthetic content. These users may want to share their augmented 3D scenes (e.g., XR rooms) with other people. The sharing of XR rooms may have multiple applications, such as for classrooms, restaurants, businesses, factories, homes (e.g., living rooms and kitchens), museums, etc. These XR rooms can be multi-functional by providing interactive information, entertainment, and/or a synthesized light experience for the users. With such XR rooms, a unified framework can be helpful to enable users navigate through the XR rooms in day-to-day life. As such, there should be a singular protocol for users to host and join these XR rooms. Without a unified framework, each XR room may need to host a unique software application (app) that every user will need to manually install onto their device (e.g., HMD) and may need create a user profile for each different app (e.g., for each different XR room). These apps can be an annoyance for the users and, thereby, significantly reduce the chance of a user to enter an XR room. These apps may also practically limit the number of XR rooms that a single user can join.

Systems, apparatuses, electronic devices, methods (also referred to as processes), and computer-readable media (collectively referred to herein as “systems and techniques”) are described herein for providing a proximity-based protocol for enabling a multi-user XR experience. In particular, the systems and techniques provide a framework for hosting and joining multi-user XR Rooms. In one or more aspects, a static host device (e.g., a wireless router) may be employed that can communicate with users' devices (e.g., users' AR/VR HMDs) using a wireless protocol. The protocol can allow for a smooth transition between different XR rooms for users based on their proximity to the host device.

A user device (e.g., an HMD or other XR device associated with a user) located within proximity to the host device can connect to the host device as an administrator. The user device, while operating as an administrator, can scan through the entire 3D scene of its environment (e.g., physical room) to capture images of the 3D scene, and the images captured by the user device can be shared with the host device. The images may be processed within the host device and/or offline (e.g., in a cloud, such as a cloud server) to generate a 3D map of the scene (e.g., containing features, such as points of interest, and geometry of the scene). The user device, while operating as an administrator, can add synthetic objects and/or lights into the scene from the obtained scene geometry.

Other users' devices (e.g., HMDs etc.) located within proximity (e.g., located within communications range) of the host device can receive broadcast messages transmitted from the host device, and can be prompted by the host device to join the XR Room. In some cases, the host device can authenticate the user devices before the users can join the XR Room. The user devices can communicate images (including image features) obtained of the physical environment surrounding the user devices to the host device. The image features from the images can be matched with the scene features at the host device to localize the users (or user devices) with respect to the XR Room. Localization of the user devices can be performed periodically to avoid localization drift (e.g., drift of a location of a particular user within the XR environment of the XR room). The host device can communicate the geometry of the synthetic content to the user devices. Each of the user devices can then render the synthetic content to the visual see-through camera view of the user device using the head/eye pose of the user associated with the user device.

The disclosed systems and techniques have a number of advantages. One advantage is that the systems and techniques provide a unified framework for users to join and host multi-user XR rooms. This generic framework can be adopted as a standard for any XR device without the need of a large overhead. This unified framework can relieve the user of the cumbersome task of needing to install custom apps for each XR room. This unified framework can also relieve the user of needing to create separate user accounts for each app for each XR room.

Another advantage is that the systems and techniques can make it easier for users to create and share XR rooms with other users, which can allow for a wide variety of applications in various different scenarios including, but not limited to, classrooms, restaurants, bars, businesses, factories, personalized homes, and museums. An additional advantage is that the systems and techniques allow for multiple users to be able to seamlessly participate in creating XR rooms. Additionally, another advantage is that the systems and techniques employ the use of local host device, which can ensure better security (e.g., by utilizing multi-modal authentication of users) and give better control for the users in setting up an XR Room.

Various aspects of the application will be described with respect to the figures.

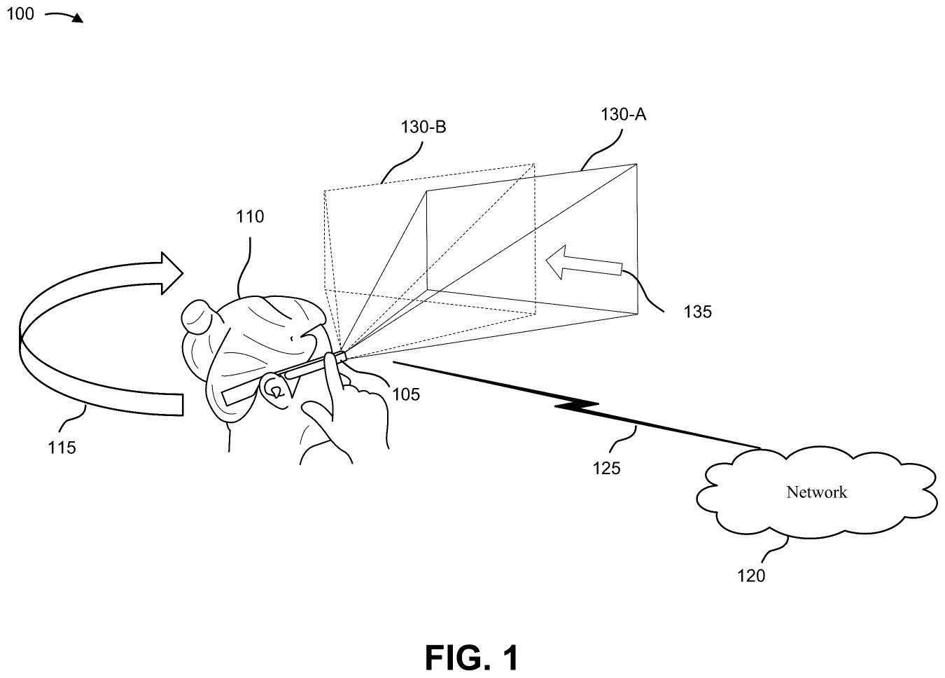

FIG. 1 illustrates an example of an extended reality system 100. As shown, the extended reality system 100 includes a device 105, a network 120, and a communication link 125. In some cases, the device 105 may be an extended reality (XR) device, which may generally implement aspects of extended reality, including virtual reality (VR), augmented reality (AR), mixed reality (MR), etc. Systems including a device 105, a network 120, or other elements in extended reality system 100 may be referred to as extended reality systems.

The device 105 may overlay virtual objects (e.g., synthetic content) with real-world objects in a view 130. For example, the view 130 may generally refer to visual input to a user 110 via the device 105, a display generated by the device 105, a configuration of virtual objects generated by the device 105, etc. For example, view 130-A may refer to visible real-world objects (also referred to as physical objects) and visible virtual objects, overlaid on or coexisting with the real-world objects, at some initial time. View 130-B may refer to visible real-world objects and visible virtual objects, overlaid on or coexisting with the real-world objects, at some later time. As discussed herein, positional differences in real-world objects (e.g., and thus overlaid virtual objects) may arise from view 130-A shifting to view 130-B at 135 due to head motion 115. In another example, view 130-A may refer to a completely virtual environment or scene at the initial time and view 130-B may refer to the virtual environment or scene at the later time.

Generally, device 105 may generate, display, project, etc. virtual objects and/or a virtual environment to be viewed by a user 110 (e.g., where virtual objects and/or a portion of the virtual environment may be displayed based on user 110 head pose prediction in accordance with the techniques described herein). In some examples, the device 105 may include a transparent surface (e.g., optical glass) such that virtual objects may be displayed on the transparent surface to overlay virtual objects on real word objects viewed through the transparent surface. Additionally or alternatively, the device 105 may project virtual objects onto the real-world environment. In some cases, the device 105 may include a camera and may display both real-world objects (e.g., as frames or images captured by the camera) and virtual objects overlaid on displayed real-world objects. In various examples, device 105 may include aspects of a virtual reality headset, a head mounted display (HMD), smart glasses, a live feed video camera, a GPU, one or more sensors (e.g., such as one or more IMUs, image sensors, microphones, etc.), one or more output devices (e.g., such as speakers, display, smart glass, etc.), etc.

In some cases, head motion 115 may include user 110 head rotations, translational head movement, etc. The device 105 may update the view 130 of the user 110 according to the head motion 115. For example, the device 105 may display view 130-A for the user 110 before the head motion 115. In some cases, after the head motion 115, the device 105 may display view 130-B to the user 110. The extended reality system (e.g., device 105) may render or update the virtual objects and/or other portions of the virtual environment for display as the view 130-A shifts to view 130-B.

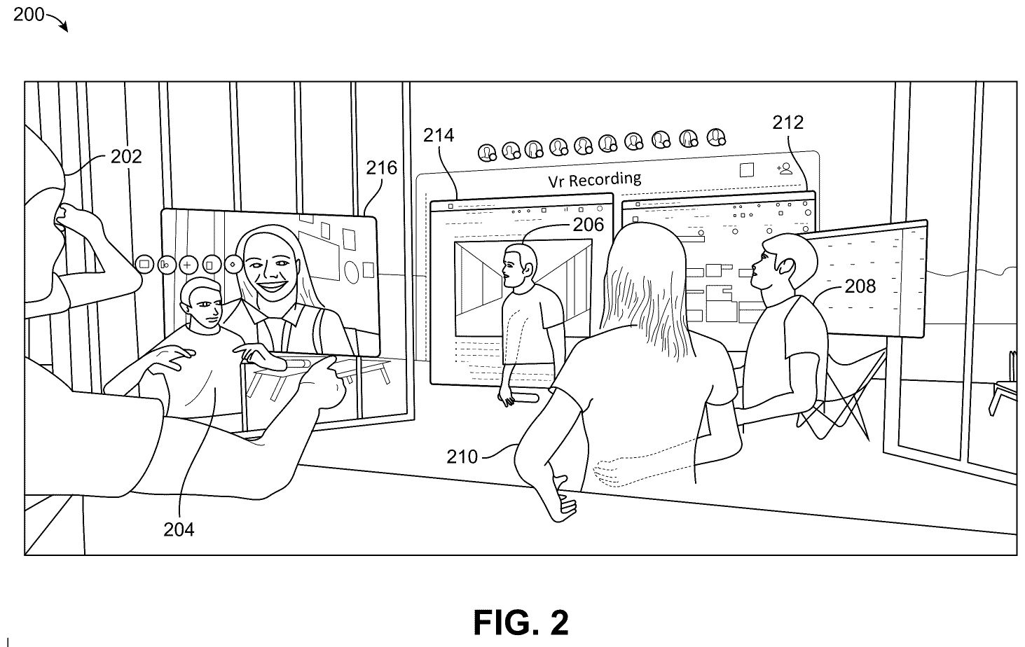

In some cases, the extended reality system 100 may provide various types of virtual experiences, such as a three-dimensional (3D) collaborative virtual environment for a group of users (e.g., including the user 110). FIG. 2 is a diagram illustrating an example of a 3D collaborative virtual environment 200 in which various users interact with one another in a virtual session via virtual representations (or avatars) of the users in the virtual environment 200. The virtual representations include including a virtual representation 202 of a first user, a virtual representation 204 of a second user, a virtual representation 206 of a third user, a virtual representation 208 of a fourth user, and a virtual representation 210 of a fifth user. Other background information of the virtual environment 200 is also shown, including a virtual calendar 212, a virtual web page 214, and a virtual video conference interface 216. The users may visually, audibly, haptically, or otherwise experience the virtual environment from each user's perspective while interacting with the virtual representations of the other users. For example, the virtual environment 200 is shown from the perspective of the first user (represented by the virtual representation 202).

As noted previously, it is important for an XR system to efficiently generate high-quality virtual representations (or avatars) with low-latency. It can also be important for the XR system to render audio in an effective manner to enhance the XR experience. For instance, in the example of the 3D collaborative virtual environment 200 of FIG. 2, an XR system of the first user (e.g., the XR system 100) displays the virtual representations 204-210 of the other users participating in the virtual session. The virtual representations 204-210 of the users and the background of the virtual environment 200 should be displayed in a realistic manner (e.g., as if the users were meeting in a real-world environment), such as by animating the heads, bodies, arms, and hands of the other users' virtual representations 204-210 as the users move in the real world. Audio captured by XR systems of the other users may need to be spatially rendered or may be rendered monophonically for output to the XR system of the first user. Latency in rendering and animating the virtual representations 204-210 should be minimal so that user experience of the first user is as if the user is interacting with the other users in the real-world environment.

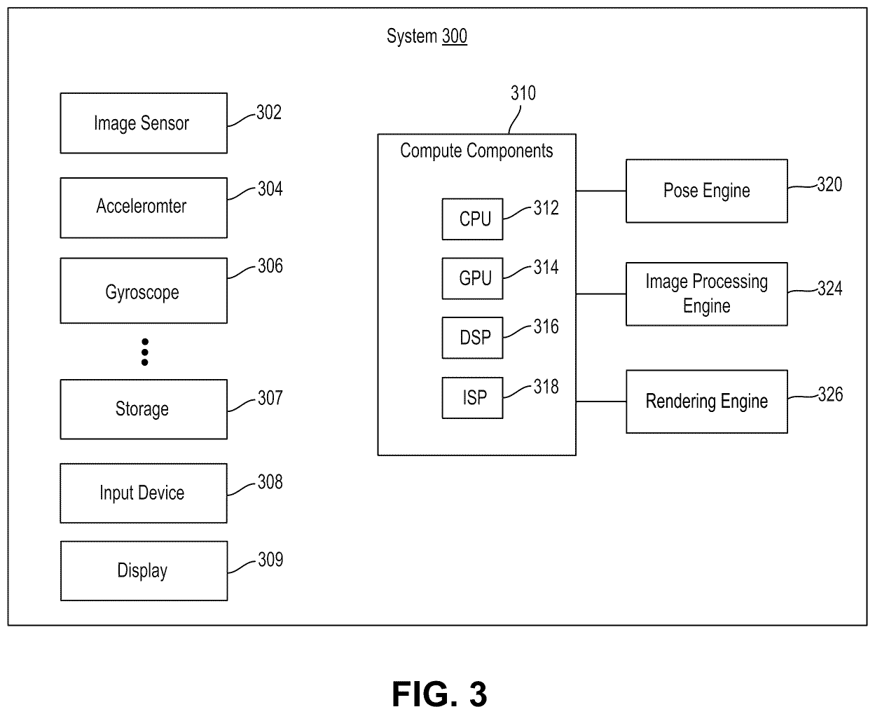

FIG. 3 is a diagram illustrating an architecture of an example system 300, in accordance with some aspects of the disclosure. The system 300 can be an XR system (e.g., running (or executing) XR applications and/or implementing XR operations), a system of a vehicle, a robotics system, or other type of system. The system 300 can perform tracking and localization, mapping of an environment in the physical world (e.g., a scene), and/or positioning and rendering of content on a display 309 (e.g., positioning and rendering of virtual content a screen, visible plane/region, and/or other display as part of an XR experience). For instance, the system 300 can generate a map (e.g., a three-dimensional (3D) map) of an environment in the physical world, track a pose (e.g., location and position) of the system 300 relative to the environment (e.g., relative to the 3D map of the environment), and/or determine a position and/or anchor point in a specific location(s) on the map of the environment. In one example, the system 300 can position and/or anchor virtual content in the specific location(s) on the map of the environment and can render virtual content on the display 309 such that the virtual content appears to be at a location in the environment corresponding to the specific location on the map of the scene where the virtual content is positioned and/or anchored. The display 309 can include a monitor, a glass, a screen, a lens, a projector, and/or other display mechanism. For example, in the context of an XR system, the display 309 can allow a user to see the real-world environment and also allows XR content to be overlaid, overlapped, blended with, or otherwise displayed thereon.

In this illustrative example, the system 300 can include one or more image sensors 302, an accelerometer 304, a gyroscope 306, storage 307, compute components 310, a pose engine 320, an image processing engine 324, and a rendering engine 326. It should be noted that the components 302-326 shown in FIG. 3 are non-limiting examples provided for illustrative and explanation purposes, and other examples can include more, less, or different components than those shown in FIG. 3. For example, in some cases, the system 300 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 3. While various components of the system 300, such as the image sensor 302, may be referenced in the singular form herein, it should be understood that the system 300 may include multiple of any component discussed herein (e.g., multiple image sensors 302).

The system 300 can include or is in communication with (wired or wirelessly) an input device 308. The input device 308 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, the image sensor 302 can capture images that can be processed for interpreting gesture commands.

In some implementations, the one or more image sensors 302, the accelerometer 304, the gyroscope 306, storage 307, compute components 310, pose engine 320, image processing engine 324, and rendering engine 326 can be part of the same computing device. For example, in some cases, the one or more image sensors 302, the accelerometer 304, the gyroscope 306, storage 307, compute components 310, pose engine 320, image processing engine 324, and rendering engine 326 can be integrated into a device or system, such as an HMD, XR glasses (e.g., AR glasses), a vehicle or system of a vehicle, smartphone, laptop, tablet computer, gaming system, and/or any other computing device. However, in some implementations, the one or more image sensors 302, the accelerometer 304, the gyroscope 306, storage 307, compute components 310, pose engine 320, image processing engine 324, and rendering engine 326 can be part of two or more separate computing devices. For example, in some cases, some of the components 302-326 can be part of, or implemented by, one computing device and the remaining components can be part of, or implemented by, one or more other computing devices.

The storage 307 can be any storage device(s) for storing data. Moreover, the storage 307 can store data from any of the components of the system 300. For example, the storage 307 can store data from the image sensor 302 (e.g., image or video data), data from the accelerometer 304 (e.g., measurements), data from the gyroscope 306 (e.g., measurements), data from the compute components 310 (e.g., processing parameters, preferences, virtual content, rendering content, scene maps, tracking and localization data, object detection data, privacy data, XR application data, face recognition data, occlusion data, etc.), data from the pose engine 320, data from the image processing engine 324, and/or data from the rendering engine 326 (e.g., output frames). In some examples, the storage 307 can include a buffer for storing frames for processing by the compute components 310.

The one or more compute components 310 can include a central processing unit (CPU) 312, a graphics processing unit (GPU) 314, a digital signal processor (DSP) 316, an image signal processor (ISP) 318, and/or other processor (e.g., a neural processing unit (NPU) implementing one or more trained neural networks). The compute components 310 can perform various operations such as image enhancement, computer vision, graphics rendering, tracking, localization, pose estimation, mapping, content anchoring, content rendering, image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 310 can implement (e.g., control, operate, etc.) the pose engine 320, the image processing engine 324, and the rendering engine 326. In other examples, the compute components 310 can also implement one or more other processing engines.

The image sensor 302 can include any image and/or video sensors or capturing devices. In some examples, the image sensor 302 can be part of a multiple-camera assembly, such as a dual-camera assembly. The image sensor 302 can capture image and/or video content (e.g., raw image and/or video data), which can then be processed by the compute components 310, the pose engine 320, the image processing engine 324, and/or the rendering engine 326 as described herein.

In some examples, the image sensor 302 can capture image data and can generate images (also referred to as frames) based on the image data and/or can provide the image data or frames to the pose engine 320, the image processing engine 324, and/or the rendering engine 326 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 302 (and/or other camera of the system 300) can be configured to also capture depth information. For example, in some implementations, the image sensor 302 (and/or other camera) can include an RGB-depth (RGB-D) camera. In some cases, the system 300 can include one or more depth sensors (not shown) that are separate from the image sensor 302 (and/or other camera) and that can capture depth information. For instance, such a depth sensor can obtain depth information independently from the image sensor 302. In some examples, a depth sensor can be physically installed in the same general location as the image sensor 302, but may operate at a different frequency or frame rate from the image sensor 302. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The system 300 can also include other sensors in its one or more sensors. The one or more sensors can include one or more accelerometers (e.g., accelerometer 304), one or more gyroscopes (e.g., gyroscope 306), and/or other sensors. The one or more sensors can provide velocity, orientation, and/or other position-related information to the compute components 310. For example, the accelerometer 304 can detect acceleration by the system 300 and can generate acceleration measurements based on the detected acceleration. In some cases, the accelerometer 304 can provide one or more translational vectors (e.g., up/down, left/right, forward/back) that can be used for determining a position or pose of the system 300. The gyroscope 306 can detect and measure the orientation and angular velocity of the system 300. For example, the gyroscope 306 can be used to measure the pitch, roll, and yaw of the system 300. In some cases, the gyroscope 306 can provide one or more rotational vectors (e.g., pitch, yaw, roll). In some examples, the image sensor 302 and/or the pose engine 320 can use measurements obtained by the accelerometer 304 (e.g., one or more translational vectors) and/or the gyroscope 306 (e.g., one or more rotational vectors) to calculate the pose of the system 300. As previously noted, in other examples, the system 300 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the system 300, using a combination of one or more accelerometers, one or more gyroscopes, and/or one or more magnetometers. In some examples, the one or more sensors can output measured information associated with the capture of an image captured by the image sensor 302 (and/or other camera of the system 300) and/or depth information obtained using one or more depth sensors of the system 300.

The output of one or more sensors (e.g., the accelerometer 304, the gyroscope 306, one or more IMUs, and/or other sensors) can be used by the pose engine 320 to determine a pose of the system 300 (also referred to as the head pose) and/or the pose of the image sensor 302 (or other camera of the system 300). In some cases, the pose of the system 300 and the pose of the image sensor 302 (or other camera) can be the same. The pose of image sensor 302 refers to the position and orientation of the image sensor 302 relative to a frame of reference (e.g., with respect to the object). In some implementations, the camera pose can be determined for 6-Degrees Of Freedom (6 DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3 DoF), which refers to the three angular components (e.g. roll, pitch, and yaw).

In some cases, a device tracker (not shown) can use the measurements from the one or more sensors and image data from the image sensor 302 to track a pose (e.g., a 6 DoF pose) of the system 300. For example, the device tracker can fuse visual data (e.g., using a visual tracking solution) from the image data with inertial data from the measurements to determine a position and motion of the system 300 relative to the physical world (e.g., the scene) and a map of the physical world. As described below, in some examples, when tracking the pose of the system 300, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the system 300 within the scene and the 3D map of the scene, etc. The 3D map can provide a digital representation of a scene in the real/physical world. In some examples, the 3D map can anchor location-based objects and/or content to real-world coordinates and/or objects. The system 300 can use a mapped scene (e.g., a scene in the physical world represented by, and/or associated with, a 3D map) to merge the physical and virtual worlds and/or merge virtual content or objects with the physical environment.

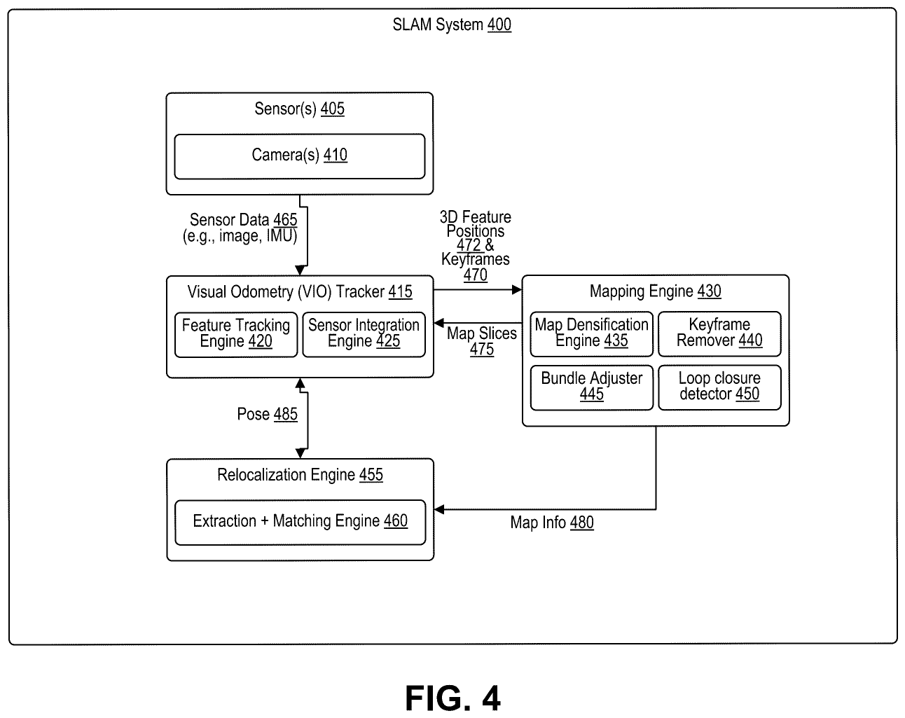

In some aspects, the pose (also referred to as a camera pose) of image sensor 302 and/or the system 300 as a whole can be determined and/or tracked by the compute components 310 using a visual tracking solution based on images captured by the image sensor 302 (and/or other camera of the system 300). For instance, in some examples, the compute components 310 can perform tracking using computer vision-based tracking, model-based tracking, and/or simultaneous localization and mapping (SLAM) techniques. For instance, the compute components 310 can perform SLAM or can be in communication (wired or wireless) with a SLAM system (not shown in FIG. 3), such as the SLAM system 400 of FIG. 4. SLAM refers to a class of techniques where a map of an environment (e.g., a map of an environment being modeled by system 300) is created while simultaneously tracking the pose of a camera (e.g., image sensor 302) and/or the system 300 relative to that map. The map can be referred to as a SLAM map, and can be three-dimensional (3D). The SLAM techniques can be performed using color or grayscale image data captured by the image sensor 302 (and/or other camera of the system 300), and can be used to generate estimates of 6 DoF pose measurements of the image sensor 302 and/or the system 300. Such a SLAM technique configured to perform 6 DoF tracking can be referred to as 6 DoF SLAM. In some cases, the output of the one or more sensors (e.g., the accelerometer 304, the gyroscope 306, one or more IMUs, and/or other sensors) can be used to estimate, correct, and/or otherwise adjust the estimated pose.

In some cases, the 6 DoF SLAM (e.g., 6 DoF tracking) can associate features (e.g., keypoints) observed from certain input images from the image sensor 302 (and/or other camera or sensor) to the SLAM map. For example, 6 DoF SLAM can use feature point associations from an input image (or other sensor data, such as a radar sensor, LIDAR sensor, etc.) to determine the pose (position and orientation) of the image sensor 302 and/or system 300 for the input image. 6 DoF mapping can also be performed to update the SLAM map. In some cases, the SLAM map maintained using the 6 DoF SLAM can contain 3D feature points (e.g., keypoints) triangulated from two or more images. For example, keyframes can be selected from input images or a video stream to represent an observed scene. For every keyframe, a respective 6 DoF camera pose associated with the image can be determined. The pose of the image sensor 302 and/or the system 300 can be determined by projecting features (e.g., feature points or keypoints) from the 3D SLAM map into an image or video frame and updating the camera pose from verified 2D-3D correspondences.

In one illustrative example, the compute components 310 can extract feature points (e.g., keypoints) from certain input images (e.g., every input image, a subset of the input images, etc.) or from each keyframe. A feature point (also referred to as a keypoint or registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in keyframes either match (are the same or correspond to) or fail to match the feature points of previously-captured input images or keyframes. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or keyframe, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

In some cases, the system 300 can also track the hand and/or fingers of the user to allow the user to interact with and/or control virtual content in a virtual environment. For example, the system 300 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

FIG. 4 is a block diagram illustrating an architecture of a simultaneous localization and mapping (SLAM) system 400. In some examples, the SLAM system 400 can be, can include, or can be a part of the system 300 of FIG. 3. In some examples, the SLAM system 400 can be, can include, or can be a part of an XR device, an autonomous vehicle, a vehicle, a computing system of a vehicle, a wireless communication device, a mobile device or handset (e.g., a mobile telephone or so-called “smart phone” or other mobile device), a wearable device (e.g., a network-connected watch), a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, a robot, another device, or any combination thereof.

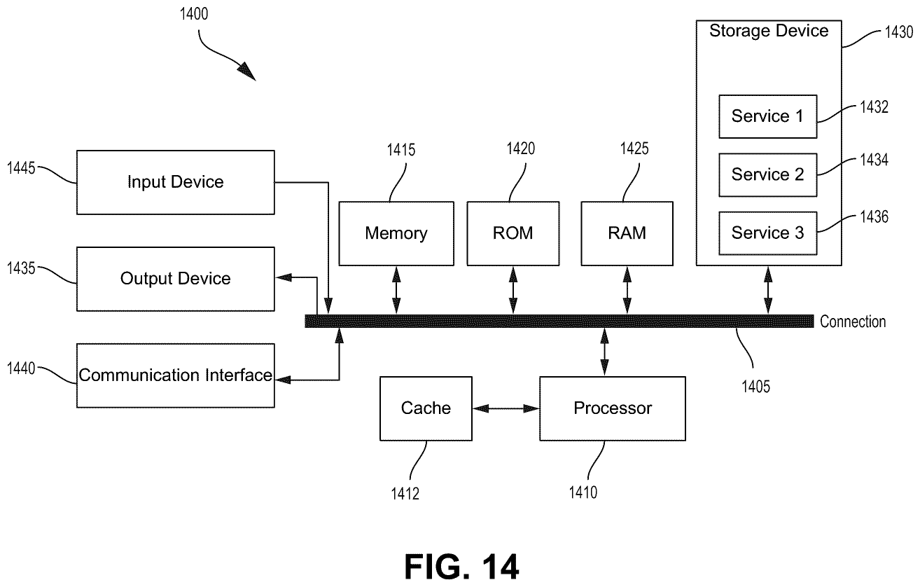

The SLAM system 400 of FIG. 4 can include, or be coupled to, each of one or more sensors 405. The one or more sensors 405 can include one or more cameras 410. Each of the one or more cameras 410 may include an image capture device, an image processing device (e.g., processor 1410 of FIG. 14), an image capture and processing system, another type of camera, or a combination thereof. Each of the one or more cameras 410 may be responsive to light from a particular spectrum of light. The spectrum of light may be a subset of the electromagnetic (EM) spectrum. For example, each of the one or more cameras 410 may be a visible light (VL) camera responsive to a VL spectrum, an infrared (IR) camera responsive to an IR spectrum, an ultraviolet (UV) camera responsive to a UV spectrum, a camera responsive to light from another spectrum of light from another portion of the electromagnetic spectrum, or some combination thereof.

The one or more sensors 405 can include one or more other types of sensors other than cameras 410, such as one or more of each of: accelerometers, gyroscopes, magnetometers, inertial measurement units (IMUs), altimeters, barometers, thermometers, radio detection and ranging (RADAR) sensors, light detection and ranging (LIDAR) sensors, sound navigation and ranging (SONAR) sensors, sound detection and ranging (SODAR) sensors, global navigation satellite system (GNSS) receivers, global positioning system (GPS) receivers, BeiDou navigation satellite system (BDS) receivers, Galileo receivers, Globalnaya Navigazionnaya Sputnikovaya Sistema (GLONASS) receivers, Navigation Indian Constellation (NavIC) receivers, Quasi-Zenith Satellite System (QZSS) receivers, Wi-Fi positioning system (WPS) receivers, cellular network positioning system receivers, Bluetooth® beacon positioning receivers, short-range wireless beacon positioning receivers, personal area network (PAN) positioning receivers, wide area network (WAN) positioning receivers, wireless local area network (WLAN) positioning receivers, other types of positioning receivers, other types of sensors discussed herein, or combinations thereof. In some examples, the one or more sensors 405 can include any combination of sensors of the system 300 of FIG. 3.

The SLAM system 400 of FIG. 4 can include a visual-inertial odometry (VIO) tracker 415. The term visual-inertial odometry may also be referred to herein as visual odometry. The VIO tracker 415 can receive sensor data 465 from the one or more sensors 405. For instance, the sensor data 465 can include one or more images captured by the one or more cameras 410. The sensor data 465 can include other types of sensor data from the one or more sensors 405, such as data from any of the types of sensors 405 listed herein. For instance, the sensor data 465 can include inertial measurement unit (IMU) data from one or more IMUs of the one or more sensors 405.

Upon receipt of the sensor data 465 from the one or more sensors 405, the VIO tracker 415 can perform feature detection, extraction, and/or tracking using a feature tracking engine 420 of the VIO tracker 415. For instance, where the sensor data 465 includes one or more images captured by the one or more cameras 410 of the SLAM system 400, the VIO tracker 415 can identify, detect, and/or extract features in each image. Features may include visually distinctive points in an image, such as portions of the image depicting edges and/or corners. The VIO tracker 415 can receive sensor data 465 periodically and/or continually from the one or more sensors 405, for instance by continuing to receive more images from the one or more cameras 410 as the one or more cameras 410 capture a video, where the images are video frames of the video. The VIO tracker 415 can generate descriptors for the features. Feature descriptors can be generated at least in part by generating a description of the feature as depicted in a local image patch extracted around the feature. In some examples, a feature descriptor can describe a feature as a collection of one or more feature vectors.

The VIO tracker 415, in some cases with the mapping engine 430 and/or the relocalization engine 455, can associate the plurality of features with a map of the environment based on such feature descriptors. The feature tracking engine 420 of the VIO tracker 415 can perform feature tracking by recognizing features in each image that the VIO tracker 415 already previously recognized in one or more previous images, in some cases based on identifying features with matching feature descriptors in different images. The feature tracking engine 420 can track changes in one or more positions at which the feature is depicted in each of the different images. For example, the feature extraction engine can detect a particular corner of a room depicted in a left side of a first image captured by a first camera of the cameras 410. The feature extraction engine can detect the same feature (e.g., the same particular corner of the same room) depicted in a right side of a second image captured by the first camera. The feature tracking engine 420 can recognize that the features detected in the first image and the second image are two depictions of the same feature (e.g., the same particular corner of the same room), and that the feature appears in two different positions in the two images. The VIO tracker 415 can determine, based on the same feature appearing on the left side of the first image and on the right side of the second image that the first camera has moved, for example if the feature (e.g., the particular corner of the room) depicts a static portion of the environment.

The VIO tracker 415 can include a sensor integration engine 425. The sensor integration engine 425 can use sensor data from other types of sensors 405 (other than the cameras 410) to determine information that can be used by the feature tracking engine 420 when performing the feature tracking. For example, the sensor integration engine 425 can receive IMU data (e.g., which can be included as part of the sensor data 465) from an IMU of the one or more sensors 405. The sensor integration engine 425 can determine, based on the IMU data in the sensor data 465, that the SLAM system 400 has rotated 15 degrees in a clockwise direction from acquisition or capture of a first image and capture to acquisition or capture of the second image by a first camera of the cameras 410. Based on this determination, the sensor integration engine 425 can identify that a feature depicted at a first position in the first image is expected to appear at a second position in the second image, and that the second position is expected to be located to the left of the first position by a predetermined distance (e.g., a predetermined number of pixels, inches, centimeters, millimeters, or another distance metric). The feature tracking engine 420 can take this expectation into consideration in tracking features between the first image and the second image.

Based on the feature tracking by the feature tracking engine 420 and/or the sensor integration by the sensor integration engine 425, the VIO tracker 415 can determine a 3D feature positions 472 of a particular feature. The 3D feature positions 472 can include one or more 3D feature positions and can also be referred to as 3D feature points. The 3D feature positions 472 can be a set of coordinates along three different axes that are perpendicular to one another, such as an X coordinate along an X axis (e.g., in a horizontal direction), a Y coordinate along a Y axis (e.g., in a vertical direction) that is perpendicular to the X axis, and a Z coordinate along a Z axis (e.g., in a depth direction) that is perpendicular to both the X axis and the Y axis. In some aspects, the VIO tracker 415 can also determine one or more keyframes 470 (referred to hereinafter as keyframes 470) corresponding to the particular feature. A keyframe (from one or more keyframes 470) corresponding to a particular feature may be an image in which the particular feature is clearly depicted. In some examples, a keyframe (from the one or more keyframes 470) corresponding to a particular feature may be an image in which the particular feature is clearly depicted. In some examples, a keyframe corresponding to a particular feature may be an image that reduces uncertainty in the 3D feature positions 472 of the particular feature when considered by the feature tracking engine 420 and/or the sensor integration engine 425 for determination of the 3D feature positions 472. In some examples, a keyframe corresponding to a particular feature also includes data about the pose 485 of the SLAM system 400 and/or the camera(s) 410 during capture of the keyframe. In some examples, the VIO tracker 415 can send 3D feature positions 472 and/or keyframes 470 corresponding to one or more features to the mapping engine 430. In some examples, the VIO tracker 415 can receive map slices 475 from the mapping engine 430. The VIO tracker 415 can feature information within the map slices 475 for feature tracking using the feature tracking engine 420.

Based on the feature tracking by the feature tracking engine 420 and/or the sensor integration by the sensor integration engine 425, the VIO tracker 415 can determine a pose 485 of the SLAM system 400 and/or of the cameras 410 during capture of each of the images in the sensor data 465. The pose 485 can include a location of the SLAM system 400 and/or of the cameras 410 in 3D space, such as a set of coordinates along three different axes that are perpendicular to one another (e.g., an X coordinate, a Y coordinate, and a Z coordinate). The pose 485 can include an orientation of the SLAM system 400 and/or of the cameras 410 in 3D space, such as pitch, roll, yaw, or some combination thereof. In some examples, the VIO tracker 415 can send the pose 485 to the relocalization engine 455. In some examples, the VIO tracker 415 can receive the pose 485 from the relocalization engine 455.

The SLAM system 400 also includes a mapping engine 430. The mapping engine 430 can generate a 3D map of the environment based on the 3D feature positions 472 and/or the keyframes 470 received from the VIO tracker 415. The mapping engine 430 can include a map densification engine 435, a keyframe remover 440, a bundle adjuster 445, and/or a loop closure detector 450. The map densification engine 435 can perform map densification, in some examples, increase the quantity and/or density of 3D coordinates describing the map geometry. The keyframe remover 440 can remove keyframes, and/or in some cases add keyframes. In some examples, the keyframe remover 440 can remove keyframes 470 corresponding to a region of the map that is to be updated and/or whose corresponding confidence values are low. The bundle adjuster 445 can, in some examples, refine the 3D coordinates describing the scene geometry, parameters of relative motion, and/or optical characteristics of the image sensor used to generate the frames, according to an optimality criterion involving the corresponding image projections of all points. The loop closure detector 450 can recognize when the SLAM system 400 has returned to a previously mapped region, and can use such information to update a map slice and/or reduce the uncertainty in certain 3D feature points or other points in the map geometry.

The mapping engine 430 can output map slices 475 to the VIO tracker 415. The map slices 475 can represent 3D portions or subsets of the map. The map slices 475 can include map slices 475 that represent new, previously-unmapped areas of the map. The map slices 475 can include map slices 475 that represent updates (or modifications or revisions) to previously-mapped areas of the map. The mapping engine 430 can output map information 480 to the relocalization engine 455. The map information 480 can include at least a portion of the map generated by the mapping engine 430. The map information 480 can include one or more 3D points making up the geometry of the map, such as one or more 3D feature positions 472. The map information 480 can include one or more keyframes 470 corresponding to certain features and certain 3D feature positions 472.

The SLAM system 400 also includes a relocalization engine 455. The relocalization engine 455 can perform relocalization, for instance when the VIO tracker 415 fail to recognize more than a threshold number of features in an image, and/or the VIO tracker 415 loses track of the pose 485 of the SLAM system 400 within the map generated by the mapping engine 430. The relocalization engine 455 can perform relocalization by performing extraction and matching using an extraction and matching engine 460. For instance, the extraction and matching engine 460 can by extract features from an image captured by the cameras 410 of the SLAM system 400 while the SLAM system 400 is at a current pose 485, and can match the extracted features to features depicted in different keyframes 470, identified by 3D feature positions 472, and/or identified in the map information 480. By matching these extracted features to the previously-identified features, the relocalization engine 455 can identify that the pose 485 of the SLAM system 400 is a pose 485 at which the previously-identified features are visible to the cameras 410 of the SLAM system 400, and is therefore similar to one or more previous poses 485 at which the previously-identified features were visible to the cameras 410.

In some cases, the relocalization engine 455 can perform relocalization based on wide baseline mapping, or a distance between a current camera position and camera position at which feature was originally captured. The relocalization engine 455 can receive information for the pose 485 from the VIO tracker 415, for instance regarding one or more recent poses of the SLAM system 400 and/or cameras 410, which the relocalization engine 455 can base its relocalization determination on. Once the relocalization engine 455 relocates the SLAM system 400 and/or cameras 410 and thus determines the pose 485, the relocalization engine 455 can output the pose 485 to the VIO tracker 415.

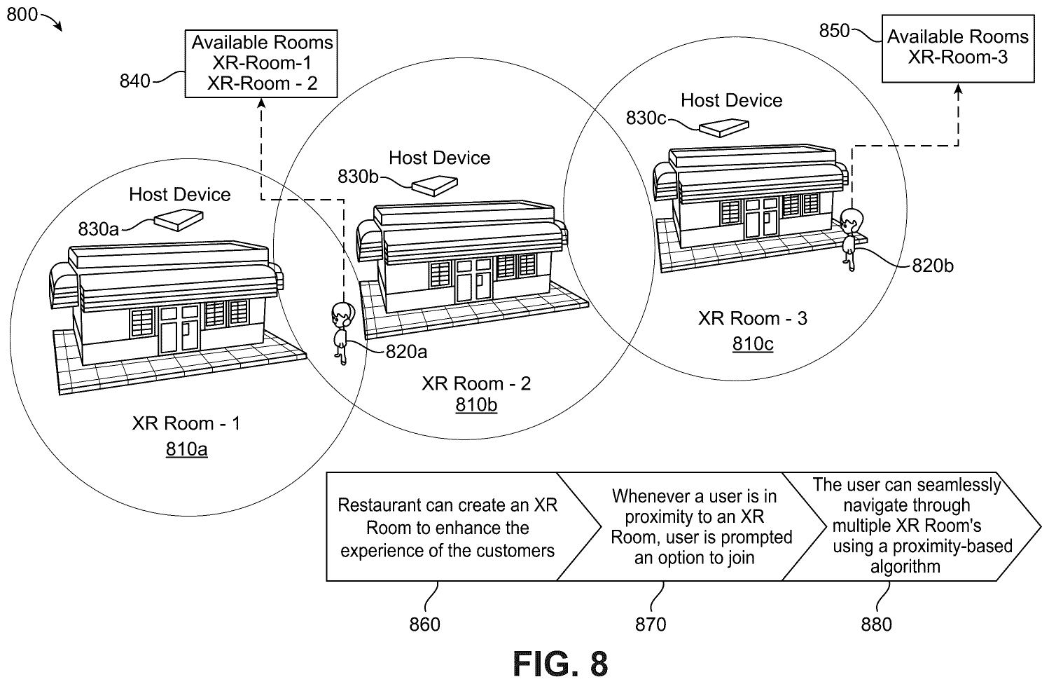

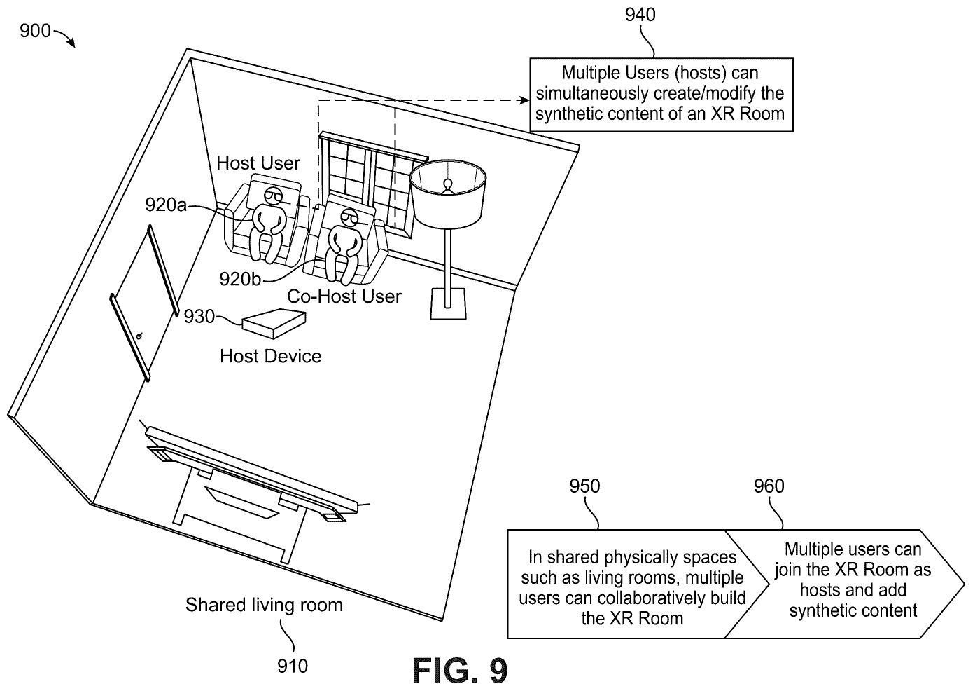

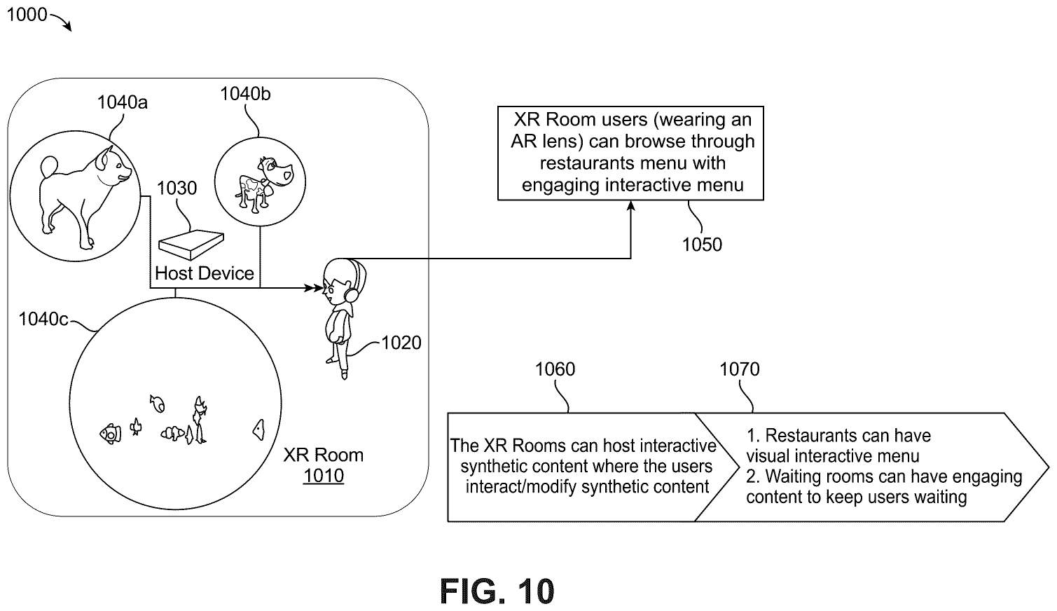

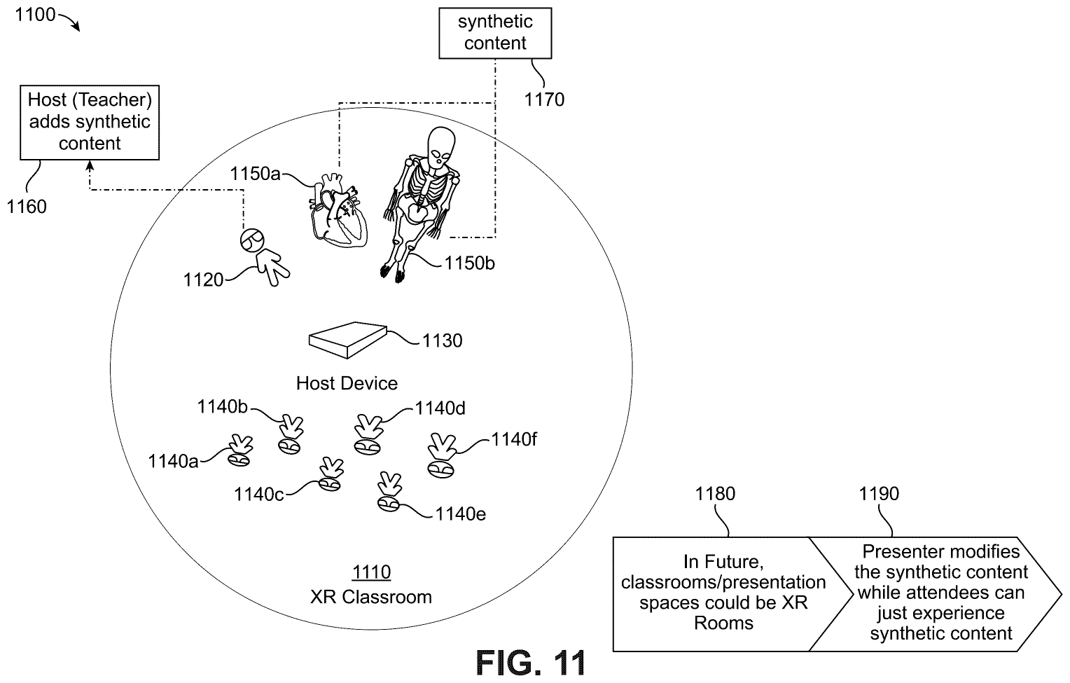

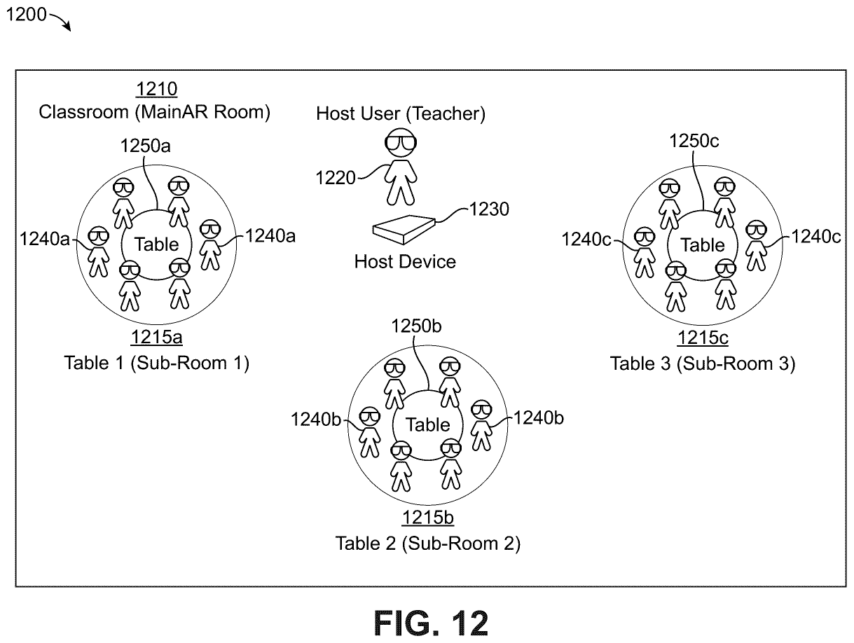

As previously noted, a user may want to augment a physical three-dimensional (3D) space surrounding the user with synthetic content. The user may want to share an augmented 3D scene (e.g., XR rooms) with other users, such as for classrooms (e.g., as shown in FIGS. 11 and 12), restaurants (e.g., as shown in FIGS. 8 and 10), businesses, factories, homes (e.g., as shown in FIG. 9), museums, etc. These XR rooms can be multi-functional by providing interactive information, entertainment, and/or a synthesized light experience for the users. With such XR rooms, the unified framework described herein can help users navigate through the XR rooms.

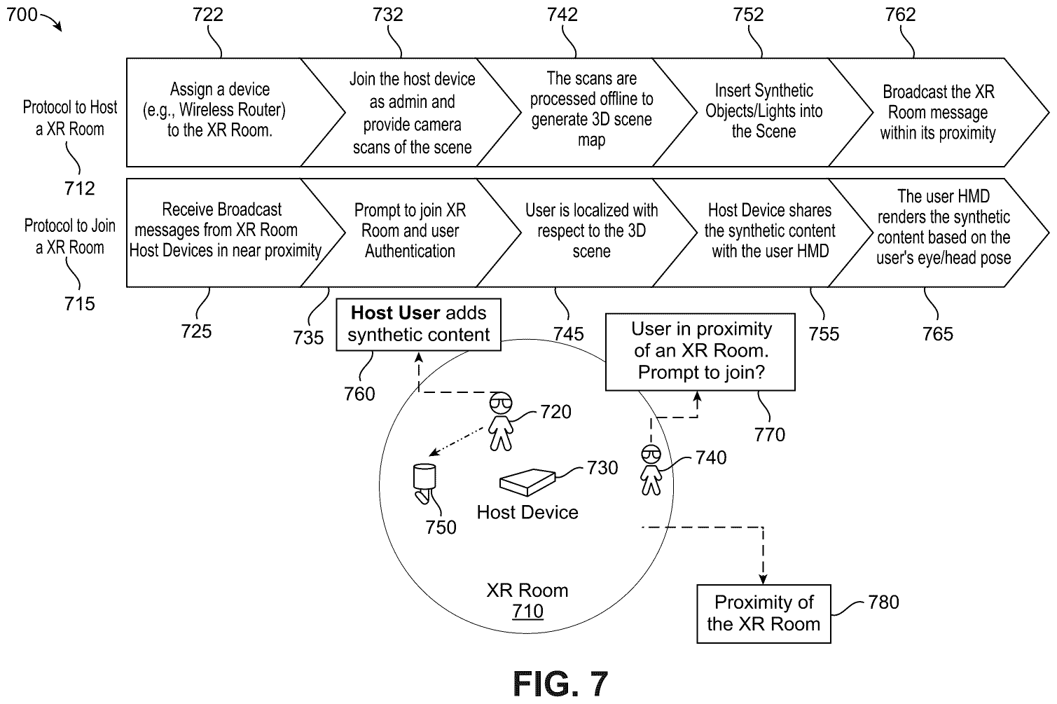

The systems and techniques provide a proximity-based protocol for enabling a multi-user XR experience. In particular, the protocol provides a unified framework for users to host and join multi-user '1XR Rooms. In one or more aspects, a static host device (e.g., host device 730 of FIG. 7, which may be a wireless router) may be employed that can communicate with users' devices, such as users' AR/VR HMDs (e.g., user HMD 720 and user HMD 740 of FIG. 7), using a wireless protocol.

During operation, a user device, such as an HMD or other XR device (e.g., user HMD 720 of FIG. 7), located proximate to the host device (e.g., host device 730 of FIG. 7) can connect to the host device as an administrator (admin). The user device, while operating as an administrator, may scan through the entire 3D scene of its environment (e.g., XR room 710 of FIG. 7, which may be a physical room) to capture images. The images captured by the user device can be transmitted to or otherwise shared with the host device. The images can be processed within the host device itself and/or offline (e.g., in a cloud, such as a cloud server) to generate a 3D map of the scene (e.g., containing features, such as points of interest, and geometry of the scene). The user device, while operating as an administrator, can add synthetic objects (e.g., synthetic content 750 of FIG. 7, in the form of a lamp, and/or lights) into the scene from the obtained scene geometry.

One or more other user devices, such as other HMDs or other XR devices (e.g., user HMD 740), located proximate (e.g., located within communications range) of the host device can receive broadcast messages transmitted from the host device. The messages can prompt the one or more other user devices to join the XR Room (e.g., XR room 710). The host device can authenticate the one or more other user devices before the users can join the XR Room. The user devices can communicate image features they have obtained of their physical location (e.g., which may have different views and perspectives of the physical location) to the host device. For example, in aspects where the user devices are HMDs, one or more of the user devices (e.g., HMDs) can provide (e.g., transmit) one or more respective images from front facing camera(s) of the HMD(s) to the host device. The host device can match the image features from the one or more other user devices with the scene features in the host device, and the host device can then localize the one or more other user devices with respect to the XR Room. For example, to localize the user device(s), the host device can detect features (e.g., points of interest) in the image(s) and match the features with a database of scene features in the host device. Localization of the one or more other user devices can be done periodically by the host device to avoid any drift. The host device can communicate the synthetic contents geometry to the one or more other user devices. Each of the one or more other user devices can render the synthetic content to the visual see-through camera view of the HMD using the head/eye pose of the user associated with the HMD.

In one or more aspects, the host device (e.g., host device 730 of FIG. 7) may be a static device, similar to a wireless router. The host device may be assigned to a particular 3D scene (e.g., a particular physical room). The user devices, such as user HMDs (e.g., user HMD 720 of FIG. 7), may vary in capability, and the host device may have the option to choose from a pool of different user HMD devices based on need.

The host device can establish peer-to-peer connections (e.g., via radio frequency communications) with multiple user devices (e.g., user HMDs, such as AR/VR user HMDs) located within proximity (e.g., within communications range) of the host device. The host device can maintain connections (e.g., maintain wireless communications) with the user HMDs within a specified range (e.g., within a twenty meters range). In one or more examples, additional devices (e.g., similar to wireless router extenders) may be employed to operate as extenders to extend the range (e.g., communications range) of the host device. These additional devices (e.g., extenders) can increase the spatial range of the host device to accommodate XR rooms of any size.

The host device can assign different permissions to users (e.g., users HMDs), such as host, administrator, guest, viewer, etc. Users (e.g., users HMDs) assigned a host permission can have the ability to add and/or modify synthetic content within the scene (e.g., within the XR room).

A user device (e.g., user HMD) may join or connect to (e.g., via a wireless communication protocol) a host device to operate as an administrator. When the user HMD is operating as an administrator (e.g., operating in administrator mode), the user HMD can provide images of the scene (e.g., the physical room) to the host device to create and/or update features (e.g., points of interest) and geometry of the scene. The user device, while operating as an administrator, can add and/or modify synthetic content to the physical scene.

The host device can store (e.g., within a host database, such as a features database) the geometry of a 3D scene, which may include both physical and synthetic content. When other user device(s) (e.g., other users' HMDs) join the 3D scene (e.g., XR room), the scene's synthetic content can be shared with the other user device(s).

The host device can periodically receive a camera feed from the other user device(s) to localize the users with respect to the 3D scene (e.g., XR room) to correct for any user's localization drift. In a more automated approach, the host device may also have a protocol to use selected camera feeds from all of the one or more other user devices to update the 3D scene (e.g., the XR room).

In one or more aspects, the user device may be an AR/VR HMD or AR glasses (or lens), which can connect to a single host device at a time. The user device (e.g., user HMD or user lens) can estimate the eye position and head pose of its associated user at all times during operation. After receiving synthetic content from a host device, the user device can render the synthetic content to the user via a see-through view of the user device. The user device may need to know the light structure, both natural and synthetic, in order to render realistic synthetic content for the physical scene (e.g., in the XR room).

As previously mentioned, currently, XR rooms typically each require the user of a specific app to join the XR room. The XR rooms are usually hosted on a cloud (e.g., cloud server), and users need to establish a connection with the cloud (e.g., cloud server), via the app, to experience the XR room. The disclosed systems and techniques employ a local host device (e.g., a wireless router) that can communicate with users' devices (e.g., users' AR/VR HMDs and/or user's AR lenses) using a wireless protocol, which can allow for a smooth transition between users and XR rooms based on the proximity of the users' devices to the host device.

The use of a local host device instead of a cloud for hosting XR rooms has a number of advantages. One advantage of using a local host device instead of a cloud for hosting XR rooms is that the use of a local host device can provide for better security than by using a cloud. For example, a hacker may create multiple duplicate identifications (IDs) in an attempt to log into a cloud to access an XR room. The generation of the many IDs by the hacker can overload the system and crash the XR room. The systems and techniques overcome this issue multiple ways through the use of the local host device. For example, the systems and techniques can robustly authenticate the users (and/or the users' devices) with the use of multi-modal data for the users to be able to join an XR room.

In one or more aspects of the systems and techniques, to be authenticated, the users (e.g., users' devices) need to be physically located within proximity (e.g., within twenty meters) of the host device, and should be able to receive broadcast messages transmitted from (e.g., located within communications range of) the host device to join the XR room. Since the communication is local between the host device and the user devices (e.g., users' HMDs), the data security can be ensured using existing wireless protocols.

In one or more examples, the users (e.g., users' devices) may be continuously authenticated by the host device using camera images from the users' devices. The host device can match the camera images from the users' devices with the 3D scene (e.g., XR room) to authenticate the users (e.g., users' devices). In one or more examples for further authentication of a user (e.g., user's device), a host device may direct the user to specifically change their view direction (e.g., move their head position or eye gaze) and to obtain additional camera images using this new viewing direction. The host device can then match these additional camera images with the 3D scene for further authentication of the user.

Another advantage of using a local host device instead of a cloud for hosting XR rooms is that the use of a local host device allows for a reduction in the use of bandwidth. Since user devices only need to maintain a connection with a host device (e.g., not with a cloud), communication data is not transmitted on wired data fibers, which can require bandwidth usage. In case of a scene update (e.g., for an XR room), the host device can broadcast the scene change to all of the user devices using only a single broadcast message. The broadcasting of a single message requires less radio frequency bandwidth than transmitting multiple messages. There is potential for the community to build protocols for the broadcasting of a single message (e.g., for a scene update to an XR room) to reduce the bandwidth usage and ensure smooth communications.

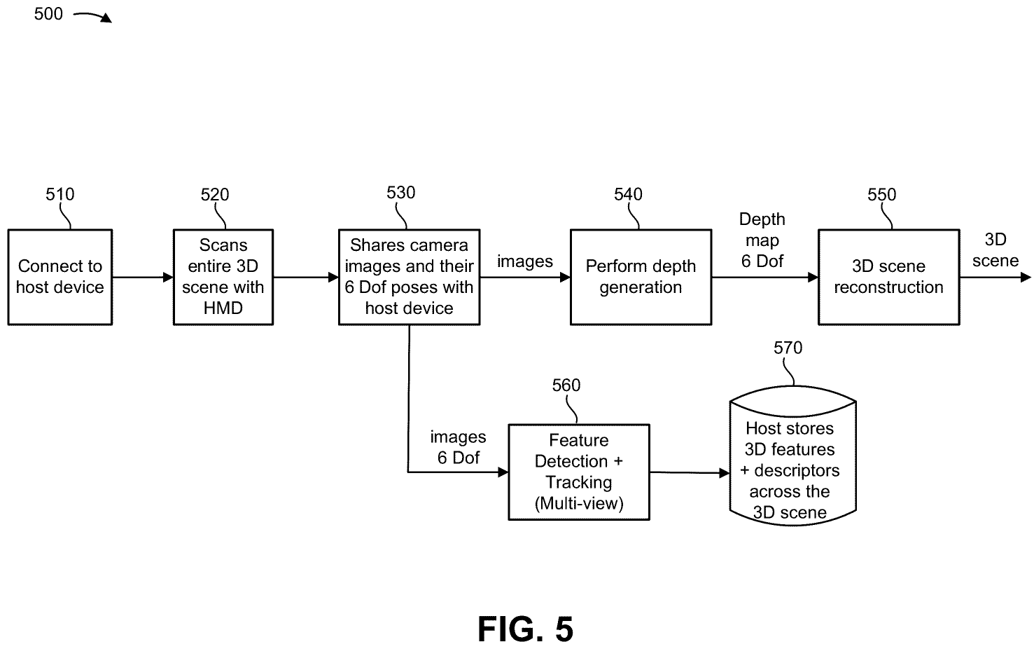

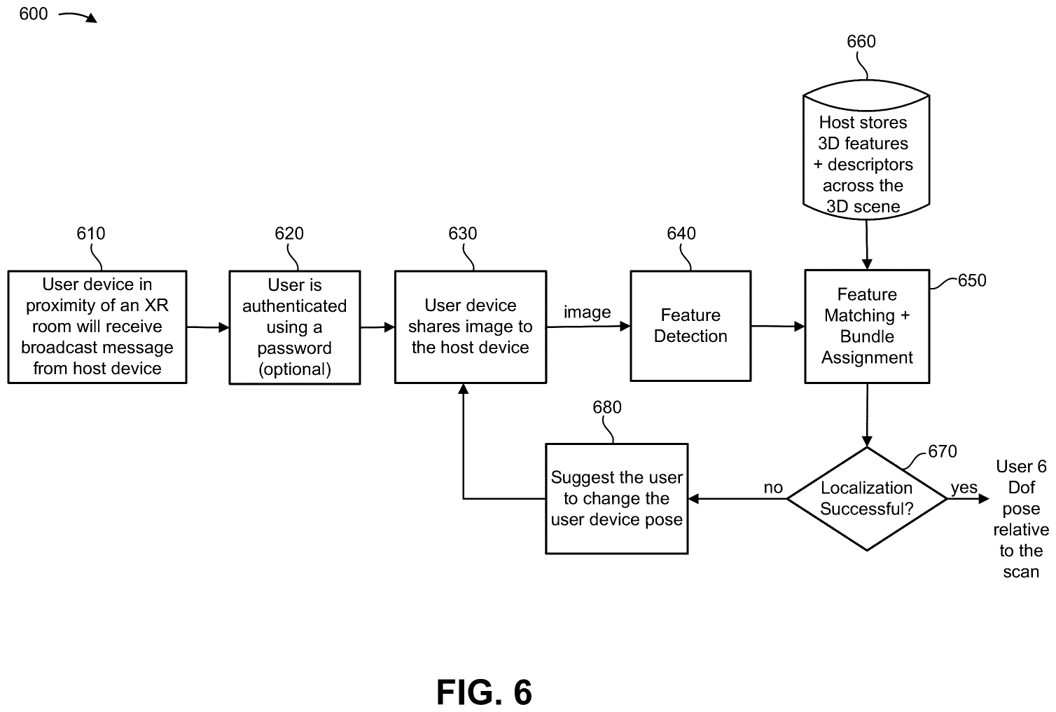

FIGS. 5 and 6 show example processes 500, 600 for enabling a multi-user XR experience. In particular, FIG. 5 is a flowchart illustrating an example of a process 500 for 3D reconstruction and generation of a features database (e.g., a host database containing features). In FIG. 5, at block 510, a user device (e.g., a user AR/VR HMD, such as user HMD 7720 of FIG. 7, or user AR lens) can connect to or join a host device (e.g., a wireless router, such as host device 730 of FIG. 7) to operate as an administrator (admin). At block 520, the user device can scan the entire 3D scene of its physical location (e.g., its physical environment) to obtain camera images of the 3D scene. At block 530, the user device can share with (e.g., transmit to) the host device the obtained camera images of the 3D scene as well as pose information of the user device (e.g., a 6 DoF pose of the user device, such as a 6 DoF head pose).

At block 540, the host device can perform depth detection or generation (e.g., using a machine learning based algorithm, a computer-vision based algorithm, or other depth generation algorithm) on the camera images of the 3D scene received from the user device to generate a depth map for each image. At block 540, the host device can then use the depth map of 6 Dof to perform 3D scene reconstruction to reconstruct the 3D scene.

At block 560, the host device can perform feature detection and tracking (e.g., for a multi-view) to obtain 3D features and descriptors by using the camera images of the 3D scene and the 6 Dof from the user device. At block 570, the host device can store (e.g., within at least one host database, such as a features database) 3D features and descriptors across the 3D scene.

FIG. 6 is a flowchart illustrating an example of a process 600 for authentication and localization of a user with a head-mounted device (HMD) (e.g., such as user HMD 720 of FIG. 7). At block 610, a user device (e.g., an HMD) located in proximity (e.g., within twenty meters) of an XR room can receive a broadcast message (e.g., a wireless radio frequency message) from a host device (e.g., host device 730 of FIG. 7). At block 620, a user of the user device (and/or the user device itself) can optionally be authenticated by using a password. For instance, the user device can transmit a password associated with the user to the host device for authentication of the user by the host device. At block 630, the user device can share with (e.g., transmit to) the host device camera images of the 3D scene obtained by the user device (e.g., the HMD).

At block 640, the host device can perform feature detection by using the camera images of the 3D scene from the user device. At block 660, the host device can have previously stored (e.g., within at least one host database, such as a features database) 3D features and descriptors across the 3D scene. At block 650, the host device can perform feature matching and bundle assignment by using the detected features from the camera images of the 3D scene from the user device and by using 3D features and descriptors across the 3D scene from at least one host database. At block 670, the host device can determine whether or not localization of the user device (e.g., user HMD) is successful. If the host device determines that the localization of the user device is successful, the host device can use the user's 6 Dof pose relative to the scan. However, if the host device determines that the localization of the user device is not successful, at block 680, the host device can suggest to the user to change his user device (e.g., user HMD) pose. Then, the process 600 proceeds back to block 630.

FIGS. 7, 8, 9, 10, 11, and 12 show different examples and applications (e.g., different use cases) for the systems and techniques for enabling a multi-user XR experience. In particular, FIG. 7 is a diagram illustrating an example 700 of users, who are located within proximity of an XR room 710, being enabled to join the XR room 710. In FIG. 7, the XR room 710 is shown to include a host device 730 (e.g., wireless router), a host user device (e.g., a host user HMD 720), and a user device (e.g., user HMD 740). A user, who is operating as an administrator, which may be referred to as a host user, is shown to be wearing the host user device (e.g., the host user HMD 720). A user who wants to join the XR room 710 is shown to be wearing the user device (e.g., the user HMD 740).

In one or more examples, during operation for a protocol 712 for a host user to host an XR room, at block 722, the host device 730 (e.g., wireless router) can be assigned to the XR room 710. At block 732, a host user device (e.g., host user HMD 720) may join the host device 730 as an administrator (or host) and can provide to the host device 730 camera scans of the entire scene obtained by the host user device (e.g., host user HMD 720). At block 742, the camera scans can be processed by the host device 730 and/or offline (e.g., within a cloud, such as a cloud server) to generate a 3D scene map. At block 752, the host user device (e.g., host user HMD 720) can insert synthetic content (e.g., host user can add synthetic content 760, such as synthetic objects, for example a synthetic lamp 750, and/or synthetic lighting) into the 3D scene. At block 762, the host device 730 can broadcast an XR room message (e.g., which can include an invitation to join the XR room) to all users (e.g., including user HMD 740) located within proximity to the host device 730.

In one or more examples, during operation for a protocol 715 for a user to join an XR room, at block 725, a user (e.g., a user device, such as user HMD 740), who is located in proximity 780 of the XR room 710, can receive broadcast messages that are transmitted from all host devices (e.g., host device 730) located in near proximity. At block 735, the user HMD 740 can be prompted 770 (e.g., via a broadcast message) to join the XR room 710 and can be authenticated by the host device 730. At block 745, the user HMD 740 can be localized by the host device 730 with respect to the 3D scene. At block 755, the host device 730 can share synthetic content (e.g., the synthetic lamp 750) with the user HMD 740. At block 765, the user HMD 740 can render the synthetic content (e.g., synthetic lamp 750) based on the user's head pose and/or eye gaze.

FIG. 8 is a diagram illustrating an example 800 of businesses (e.g., restaurants) having respective XR rooms. In FIG. 8, three physical restaurants are shown. As shown in FIG. 8, at block 860, in the future, every restaurant can create an XR room (e.g., XR room 1 810a, XR room 2 810b, XR room 3 810c) to enhance the experience of the customers (e.g., by generating synthetic content, such as synthetic interactive menus, for the customers). At block 870, whenever a user is located within proximity to an XR room, he can be prompted with the option to join the XR room. At block 880, a user can seamlessly navigate through multiple XR rooms with a simple proximity-based algorithm.

Each restaurant is shown in FIG. 8 to have a respective host device (e.g., host devices 830a, 830b, 830c) and have a respective XR room (e.g., XR room 1 810a, XR room 2 810b, XR room 3 810c). Each XR room is associated with a host device. Also shown are two users, who are each associated with a user device (e.g., user HMDs 820a, 820b). User HMD 820a is located within proximity (e.g., within twenty meters) of host device 830a and host device 830b. As such, XR room 1 810a and XR room 2 810b are available 840 for user HMD 820a to join. User HMD 820b is located within proximity (e.g., within twenty meters) of host device 830c. As such, XR room 3 810c is available 850 for user HMD 820b to join.

FIG. 9 is a diagram illustrating an example 900 of users co-hosting an XR room. In FIG. 9, a shared living room 910 of a house is shown. As shown in FIG. 9, at block 950, in shared physical spaces (e.g., such as shared living room 910), multiple users can collaboratively build an XR room. At block 960, multiple users can join the XR room as hosts (e.g., operating as administrators or hosts) and add synthetic content to the 3D scene.

In FIG. 9, a host device 930 and two users are shown to be located within the shared living room 910. One user may operate as a host user and is associated with a user device (e.g., host user HMD 920a). The other user may operate as a co-host user and is associated with a user device (e.g., co-host user HMD 920b). Both users within the shared living space 910 may operate as hosts (or administrators) 940 and, as such, can simultaneously create and/or modify synthetic content for the XR room for the shared living space 910.

FIG. 10 is a diagram illustrating an example 1000 of a user interacting with synthetic content (e.g., synthetic content 1040a, 1040b, 1040c) within an XR room 1010. In FIG. 10, an XR room 1010 for a business (e.g., restaurant) is shown to include a host device 1030. As shown in FIG. 10, at block 1060, XR rooms (e.g., XR room 1010) can host interactive synthetic content (e.g., synthetic menus) where users can interact and/or modify the synthetic content. At block 1070, for example, restaurants can have visual interactive menus, and waiting rooms (e.g., at doctor's offices) can have engaging synthetic content to entertain users while they are waiting for their appointment.

In FIG. 10, a user, who is associated with a user device (e.g., wearing a user AR lens 1020) is shown to be within the XR room 1010 of the business (e.g., restaurant). All users wearing user devices (e.g., user AR lens, such as user AR lens 1020) and joined within the XR room 1010 can browse and engage 1050 with the restaurant's synthetic menu. For example, the synthetic menu may include synthetic content 1040a, 1040b, 1040c, as shown in FIG. 10.

FIG. 11 is a diagram illustrating an example 1100 of an XR classroom. In FIG. 11, an XR classroom 1110 for a school is shown to include a host device 1130, a user (e.g., teacher) associated with a user device (e.g., user HMD 1120), and users (e.g., students) associated with user devices (e.g., user HMDs 1140a, 1140b, 1140c, 1140d, 1140e, 1140f). As shown in FIG. 11, at block 1080, in the future, classrooms and/or presentation spaces can have XR rooms (e.g., XR classroom 1110). At block 1190, a presenter (e.g., teacher) can modify synthetic content (e.g., synthetic content 1150a in the form of a heart and synthetic content 1150b in the form of a skeleton) while attendees (e.g., students) can experience the synthetic content.

In FIG. 11, a host user (e.g., teacher) can add 1160 synthetic content (e.g., synthetic content 1170 including synthetic content 1150a and synthetic content 1150b) to the XR classroom 1110 by using his associated user HMD 1120. The students in the XR classroom 1110 can view and interact with the synthetic content 1170 (e.g., including synthetic content 1150a and synthetic content 1150b) by using their associated user HMDs 1140a, 1140b, 1140c, 1140d, 1140e, 1140f.

FIG. 12 is a diagram illustrating an example 1200 of XR sub-rooms (e.g., XR sub-room 1 1215a, XR sub-room 2 1215b, and XR sub-room 3 1215c) within an XR classroom 1210 (e.g., main AR room). In FIG. 11, an XR classroom 1210 for a school is shown to include tables 1250a, 1250b 1250c, a host device 1230, a user (e.g., teacher) associated with a user device (e.g., user HMD 1220), and users (e.g., students) associated with user devices (e.g., user HMDs 1240a, 1240b, 1240c). Each table 1250a, 1250b 1250c is associated with a respective XR sub-room.

The possibility of having XR sub-rooms (e.g., XR sub-room 1 1215a, XR sub-room 2 1215b, and XR sub-room 3 1215c) within an XR room (e.g., XR classroom 1210), as shown in FIG. 11, provides options to personalize the XR room experiences for the users (e.g., personalize learning interactions with synthetic content for students). Within the same main AR room (e.g., XR classroom 1210), different users can have different experiences based on the users being assigned to different XR sub-rooms. The users can be assigned to different XR sub-rooms based on the users' properties (e.g., users' age, vision (color blindness), etc.). In one or more examples, the main AR room can be a classroom or a personal house, etc.

In another illustrative example of an application of the systems and techniques described herein, an interactive XR room is a grocery store and users in proximity of the grocery store have XR devices that allow the users to join the XR room. After joining, if a user wants to know a physical location of a product, the user can utilize an XR device (e.g., an HMD) to interact with the XR room. When the user joins the XR room using their XR device, the XR room can render virtual directions to the product only specific to the user.

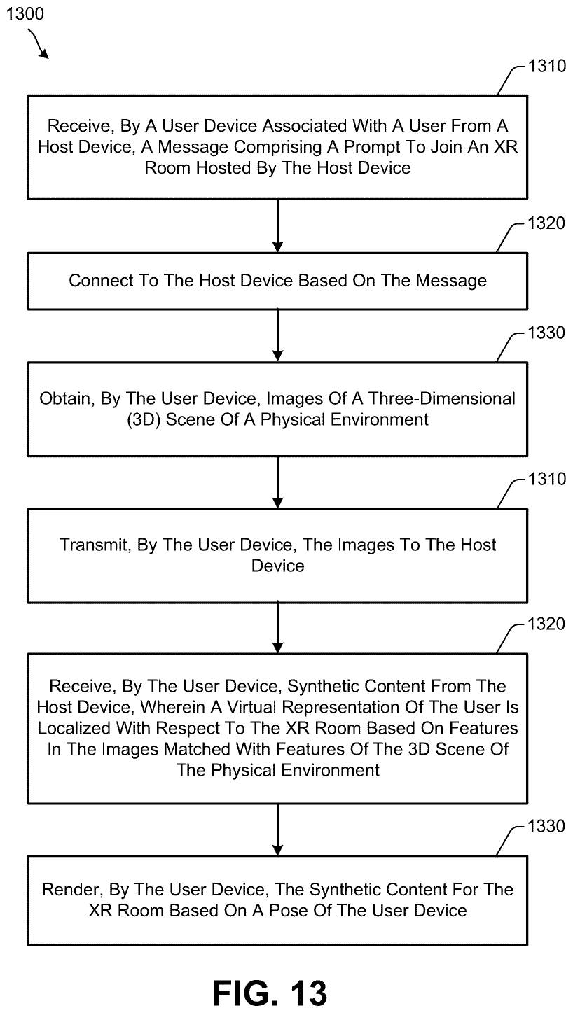

FIG. 13 is a flow chart illustrating an example of a process 1300 for enabling a multi-user XR experience. The process 1300 can be performed by a user device of a user (or computing device apparatus), or a component or system (e.g., a chipset) of the user device. The user device (or component or system thereof) can include or can be the system 300 of FIG. 3, the computing system 1400 of FIG. 14, or other system or device. In some aspects, the user device is an XR device (e.g., an AR/VR HMD, AR glasses or AR lens, etc.). The operations of the process 1300 may be implemented as software components that are executed and run on one or more processors (e.g., processor 1410 of FIG. 14 or other processor(s)). Further, the transmission and reception of signals by the first network entity in the process 1300 may be enabled, for example, by one or more antennas and/or one or more transceivers such as wireless transceiver(s) (e.g., using communication interface 1440 of the computing system 1400 of FIG. 14).

At block 1310, the user device (or component thereof) can receive, from a host device, a message comprising a prompt to join an XR room hosted by the host device. The user device can be located within a communication range of the host device In some aspects, the host device is a wireless router (e.g., an 802.11x/WiFi router) and the user device is within communication range of the router. In some cases, the message is a broadcast message.

At block 1320, the user device (or component thereof) can connect to the host device based on the message. In some aspects, the user device (or component thereof) can transmit, to the host device, a password for authentication of the user. In such aspects, upon being authenticated, the user device can connect to the hose device.

At block 1330, the user device (or component thereof) can obtain images of a three-dimensional (3D) scene of a physical environment. At block 1340, the user device (or component thereof) can transmit the images to the host device.

At block 1350, the user device (or component thereof) can receive synthetic content from the host device. A virtual representation of the user is localized with respect to the XR room based on features in the images matched with features of the 3D scene of the physical environment. The synthetic content can include synthetic objects, one or more lighting effects, and/or other synthetic or virtual content.

At block 1360, the user device (or component thereof) can render the synthetic content for the XR room based on a pose of the user device. In some cases, the pose of the user corresponds to at least one of a pose of a head of the user or a direction of eyes of the user.

The user device (or computing device or apparatus) can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 1300, and/or other process described herein. In some cases, the user device can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the user device may include a display, a network interface configured to communicate and/or receive the data, any combination thereof, and/or other component(s). The network interface may be configured to communicate and/or receive Internet Protocol (IP) based data or other type of data.

The components of the user device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1300 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 1300 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a diagram illustrating an example of a system for implementing certain aspects of the present technology. In particular, FIG. 14 illustrates an example of computing system 1400, which can be for example any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some embodiments, computing system 1400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1400 includes at least one processing unit (CPU or processor) 1410 and connection 1405 that couples various system components including system memory 1415, such as read-only memory (ROM) 1420 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400. Computing system 1400 can include communications interface 1340, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memory storage, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some embodiments, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method for providing an extended reality (XR) experience, the method comprising: receiving, by a user device associated with a user from a host device, a message comprising a prompt to join an XR room hosted by the host device; connecting to the host device based on the message; obtaining, by the user device, images of a three-dimensional (3D) scene of a physical environment; transmitting, by the user device, the images to the host device;

receiving, by the user device, synthetic content from the host device, wherein a virtual representation of the user is localized with respect to the XR room based on features in the images matched with features of the 3D scene of the physical environment; and rendering, by the user device, the synthetic content for the XR room based on a pose of the user device.

Aspect 2. The method of Aspect 1, wherein the user device is one of an augmented reality/virtual reality (AR/VR) head-mounted device (HMD) or an augmented reality (AR) lens.

Aspect 3. The method of any one of Aspects 1 or 2, wherein the host device is a wireless router.

Aspect 4. The method of any one of Aspects 1 to 3, wherein the message is a broadcast message.

Aspect 5. The method of any one of Aspects 1 to 4, further comprising transmitting, by the user device to the host device, a password for authentication of the user.

Aspect 6. The method of any one of Aspects 1 to 5, wherein the user device is located within a communication range of the host device.

Aspect 7. The method of any one of Aspects 1 to 6, wherein the pose of the user corresponds to at least one of a pose of a head of the user or a direction of eyes of the user.

Aspect 8. The method of any one of Aspects 1 to 7, wherein the synthetic content comprises at least one of one or more synthetic objects or one or more lighting effects.

Aspect 9. An apparatus associated with a user for providing an extended reality (XR) experience, the apparatus comprising: at least one memory; and at least one processor coupled to the at least one memory and configured to: receive, from a host device, a message comprising a prompt to join an XR room hosted by the host device; connect to the host device based on the message; obtain images of a three-dimensional (3D) scene of a physical environment; transmit the images to the host device; receive synthetic content from the host device, wherein a virtual representation of the user is localized with respect to the XR room based on features in the images matched with features of the 3D scene of the physical environment; and render the synthetic content for the XR room based on a pose of the apparatus.

Aspect 10. The apparatus of Aspect 9, wherein the apparatus is one of an augmented reality/virtual reality (AR/VR) head-mounted device (HMD) or an augmented reality (AR) lens.

Aspect 11. The apparatus of any one of Aspects 9 or 10, wherein the host device is a wireless router.

Aspect 12. The apparatus of any one of Aspects 9 to 11, wherein the message is a broadcast message.

Aspect 13. The apparatus of any one of Aspects 9 to 12, wherein the at least one processor is configured to transmit, to the host device, a password for authentication of the user.

Aspect 14. The apparatus of any one of Aspects 9 to 13, wherein the apparatus is located within a communication range of the host device.

Aspect 15. The apparatus of any one of Aspects 9 to 14, wherein the pose of the user corresponds to at least one of a pose of a head of the user or a direction of eyes of the user.

Aspect 16. The apparatus of any one of Aspects 9 to 15, wherein the synthetic content comprises at least one of one or more synthetic objects or one or more lighting effects.

Aspect 17. A non-transitory computer-readable medium of a user device associated with a user, the non-transitory computer-readable medium having instructions that, when executed by at least one processor, cause the at least one processor to: receive, from a host device, a message comprising a prompt to join an XR room hosted by the host device; connect to the host device based on the message; obtain images of a three-dimensional (3D) scene of a physical environment; transmit the images to the host device; receive synthetic content from the host device, wherein a virtual representation of the user is localized with respect to the XR room based on features in the images matched with features of the 3D scene of the physical environment; and render the synthetic content for the XR room based on a pose of the user device.

Aspect 18. The non-transitory computer-readable medium of Aspect 17, wherein the apparatus is one of an augmented reality/virtual reality (AR/VR) head-mounted device (HMD) or an augmented reality (AR) lens.

Aspect 19. The non-transitory computer-readable medium of any one of Aspects 17 or 18, wherein the host device is a wireless router.

Aspect 20. The non-transitory computer-readable medium of any one of Aspects 17 to 19, wherein the message is a broadcast message.

Aspect 21. The non-transitory computer-readable medium of any one of Aspects 17 to 20, wherein the instructions, when executed by the at least one processor, cause the at least one processor to transmit, to the host device, a password for authentication of the user.

Aspect 22. The non-transitory computer-readable medium of any one of Aspects 17 to 21, wherein the apparatus is located within a communication range of the host device.

Aspect 23. The non-transitory computer-readable medium of any one of Aspects 17 to 22, wherein the pose of the user corresponds to at least one of a pose of a head of the user or a direction of eyes of the user.

Aspect 24. The non-transitory computer-readable medium of any one of Aspects 17 to 23, wherein the synthetic content comprises at least one of one or more synthetic objects or one or more lighting effects.

Aspect 25. An apparatus for providing an extended reality (XR) experience, comprising one or more means for performing operations according to any of Aspects 1 to 8.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A method for providing an extended reality (XR) experience, the method comprising:
receiving, by a user device associated with a user from a host device, a message comprising a prompt to join an XR room hosted by the host device;
connecting to the host device based on the message;
obtaining, by the user device, images of a three-dimensional (3D) scene of a physical environment;
transmitting, by the user device, the images to the host device;
receiving, by the user device, synthetic content from the host device, wherein a virtual representation of the user is localized with respect to the XR room based on features in the images matched with features of the 3D scene of the physical environment; and
rendering, by the user device, the synthetic content for the XR room based on a pose of the user device.

2. The method of claim 1, wherein the user device is one of an augmented reality/virtual reality (AR/VR) head-mounted device (HMD) or an augmented reality (AR) lens.

3. The method of claim 1, wherein the host device is a wireless router.

4. The method of claim 1, wherein the message is a broadcast message.

5. The method of claim 1, further comprising transmitting, by the user device to the host device, a password for authentication of the user.

6. The method of claim 1, wherein the user device is located within a communication range of the host device.

7. The method of claim 1, wherein the pose of the user corresponds to at least one of a pose of a head of the user or a direction of eyes of the user.

8. The method of claim 1, wherein the synthetic content comprises at least one of one or more synthetic objects or one or more lighting effects.

9. An apparatus associated with a user for providing an extended reality (XR) experience, the apparatus comprising:
at least one memory; and
at least one processor coupled to the at least one memory and configured to:
receive, from a host device, a message comprising a prompt to join an XR room hosted by the host device;
connect to the host device based on the message;
obtain images of a three-dimensional (3D) scene of a physical environment;
transmit the images to the host device;
receive synthetic content from the host device, wherein a virtual representation of the user is localized with respect to the XR room based on features in the images matched with features of the 3D scene of the physical environment; and
render the synthetic content for the XR room based on a pose of the apparatus.

10. The apparatus of claim 9, wherein the apparatus is one of an augmented reality/virtual reality (AR/VR) head-mounted device (HMD) or an augmented reality (AR) lens.

11. The apparatus of claim 9, wherein the host device is a wireless router.

12. The apparatus of claim 9, wherein the message is a broadcast message.

13. The apparatus of claim 9, wherein the at least one processor is configured to transmit, to the host device, a password for authentication of the user.

14. The apparatus of claim 9, wherein the apparatus is located within a communication range of the host device.

15. The apparatus of claim 9, wherein the pose of the user corresponds to at least one of a pose of a head of the user or a direction of eyes of the user.

16. The apparatus of claim 9, wherein the synthetic content comprises at least one of one or more synthetic objects or one or more lighting effects.

17. A non-transitory computer-readable medium of a user device associated with a user, the non-transitory computer-readable medium having instructions that, when executed by at least one processor, cause the at least one processor to:
receive, from a host device, a message comprising a prompt to join an XR room hosted by the host device;
connect to the host device based on the message;
obtain images of a three-dimensional (3D) scene of a physical environment;
transmit the images to the host device;
receive synthetic content from the host device, wherein a virtual representation of the user is localized with respect to the XR room based on features in the images matched with features of the 3D scene of the physical environment; and
render the synthetic content for the XR room based on a pose of the user device.

18. The non-transitory computer-readable medium of claim 17, wherein the apparatus is one of an augmented reality/virtual reality (AR/VR) head-mounted device (HMD) or an augmented reality (AR) lens.

19. The non-transitory computer-readable medium of claim 17, wherein the host device is a wireless router.

20. The non-transitory computer-readable medium of claim 17, wherein the message is a broadcast message.

21. The non-transitory computer-readable medium of claim 17, wherein the instructions, when executed by the at least one processor, cause the at least one processor to transmit, to the host device, a password for authentication of the user.

22. The non-transitory computer-readable medium of claim 17, wherein the apparatus is located within a communication range of the host device.

23. The non-transitory computer-readable medium of claim 17, wherein the pose of the user corresponds to at least one of a pose of a head of the user or a direction of eyes of the user.

24. The non-transitory computer-readable medium of claim 17, wherein the synthetic content comprises at least one of one or more synthetic objects or one or more lighting effects.
